(19) United States
(12) Patent Application Publication
(10) Pub. No.: US 2005/0036143 A1
(43) Pub. Date: Feb. 17, 2005

(54) Reference calibration of metrology instrument

(75) Inventor: Chunsheng Huang, San Jose, CA (US)

Correspondence Address: SILICON VALLEY PATENT GROUP LLP, 2350 MISSION COLLEGE BOULEVARD, SUITE 360, SANTA CLARA, CA, 95054, US

(73) Assignee: Nanometrics Incorporated, Milpitas, CA (US)

(21) Appl. No.: 10/642,808

(22) Filed: Aug. 15, 2003

(51) Int. Cl. G01J 4/00

(52) U.S. Cl. 356/369

(57) ABSTRACT

A metrology instrument is calibrated using two reference locations with different optical properties designed to produce different measurement results, e.g., different thicknesses. The metrology instrument, for example, may be an ellipsometer with a variable phase retarder. By comparing initial measurements of the two reference locations with later measurements of the two reference locations, the amount of calibration error can be easily determined. In addition, an ellipsometer having a spatially or temporally variable phase retarder may also be calibrated with a single reference location.

### FIELD OF THE INVENTION

The present invention is related to optical metrology and in particular to a calibration technique for a metrology device that uses a spatial and/or temporal phase modulation as a component of an ellipsometer.

### BACKGROUND

There is always a need for precise and reliable metrology to monitor the properties of thin films, especially in the semiconductor and magnetic head industries. Thin film properties of interest include the thickness of one or more layers, the surface roughness, the interface roughness between different layers, the optical properties of the different layers, the compositional properties of the different layers and the compositional uniformity of the film stack. Ellipsometers are particularly well suited to this task when the thickness is less than 100 nm, when there are more than two layers present or when there are compositional variations. Additionally, dimensional measurements such as linewidth, sidewall angle and height can be extracted using ellipsometry.

An ellipsometer is a measurement tool used to determine the change in polarization state of an electromagnetic wave after interaction with a sample. The determination of this polarization state can yield information about the thin film properties such as those listed above. In general, an ellipsometer is a polarization-state-in, polarization-state-out device. FIG. 1 shows a simple block diagram of a typical ellipsometer 10, which includes a Polarization State Generator (PSG) 12 that generates an electromagnetic wave of a known polarization state and a Polarization State Detector (PSD) 16 that determines the polarization state of the electromagnetic wave after interaction with a sample 14. In FIG. 1 the interaction is shown in reflection mode, but it should be understood that the interaction may be in transmission mode, i.e., the PSD determines the polarization state of the electromagnetic wave after transmission through a sample.

Different kinds of PSG/PSD configurations have been proposed and developed for ellipsometers. The advantages of each configuration are specific to the kind of extracted information that is desired. In the thin film metrology field, the most popular ellipsometry configurations include a rotating polarizing element. In these systems, the PSG and/or the PSD contain a rotating polarizing element utilizing a polarizer or compensator.

Unfortunately, rotating element configurations require moving parts employing motors, and therefore are more difficult to design into a compact tool. Compactness is a necessity for an application where the metrology module is integrated into a semiconductor process tool. Furthermore, moving components require maintenance and calibration and may degrade the reliability of the metrology tool.

Another kind of ellipsometer that has been extensively developed and used for thin film metrology is the photoelastic modulator ellipsometer (PME). This instrument employs a photoelastic modulator (PM) to change the polarization state of the light as a function of time either before or after reflection from the sample surface. This modulation can also be accomplished using a Pockels cell or liquid crystal variable retarders instead of a PM. One advantage of the PME is the lack of moving parts as the polarization is manipulated electrically.

FIG. 2 is a block diagram of a conventional PME 20. The PSG portion 21 of the PME 20 includes a light source 22 and a linear polarizer 24. The light source 22 generates a collimated beam (monochromatic or broadband radiation) that is transmitted through the linear polarizer 24. The linearly polarized beam is reflected from the sample surface 26 thereby modifying the polarization state of the electromagnetic beam. The PSD portion 27 of the PME 20 includes a PM (or Pockels cell) 28, another linear polarizer 30, and a detector 32. The PM (or Pockels cell) 28 introduces a time-dependent phase between the x- and y- electric field components of the reflected beam in relation to the optical axis of the PM 28. The linear polarizer 30 modulates the intensity of the incoming beam as a function of the phase imposed by the PM, which is a function of time. The detector 32 records the time-dependent intensity of the electromagnetic beam. The detector 32 can be a single element detector for a single wavelength system or a multichannel spectrograph when multiple wavelengths are used. Other configurations of a PME include a single PM in the PSG instead of the PSD, or a PM in both the PSG and the PSD.

Unfortunately, photoelastic modulators and Pockels cells are relatively large and expensive. Consequently, a disadvantage of an ellipsometer configuration employing modulated polarization such as shown in FIG. 2, is the larger size and greater cost relative to an ellipsometer that does not employ modulated polarization.

U.S. patent application Ser. No. 09/929,625, filed Aug. 13, 2001, entitled “Metrology Device and Method Using a Spatial Variable Phase Retarder”, which is incorporated herein by reference described a metrology configuration that advantageously does not use moving parts or a phase modulator to measure a sample. Calibration of the system, however, requires a periodic reference measurement, which can be time consuming. Moreover, optical components of the system, e.g., the variable retarder, are moved out of the beam path during the reference measurement. Thus, there is a need for an improved system in which calibration reference data that can be easily and quickly measured.

### SUMMARY

In accordance with an embodiment of the present invention, a metrology instrument is calibrated using two reference locations on one or two separate chips that are designed to produce different measurement results, e.g., different thicknesses. In one embodiment, the metrology device may be an ellipsometer having either a spatially or temporally variable phase retarder. By comparing initial measurements of the two reference locations with later measurements of the two reference locations, the amount of calibration error can be easily determined. In another embodiment, an ellipsometer having a spatially or temporally variable phase retarder is calibrated using a single reference location.

One embodiment of the present invention is a method of calibrating a metrology instrument. The method includes producing initial measurements of a first reference location and a second reference location, wherein the first reference location and the second reference location are designed with different optical properties to produce different measurement results. The method further includes producing subsequent measurements of the first reference location and the second reference location. The initial measurements of the first reference location and the second reference location are then used with the subsequent measurements of the first reference location and the second reference location to determine the calibration error of the metrology instrument.

Another embodiment of the present invention is a method of calibrating an ellipsometer, which includes producing an initial measurement of at least one reference location and producing a subsequent measurement of the at least one reference location. The initial measurement of the least one reference location is used with the subsequent measurement of the least one reference location to determine the calibration error of the ellipsometer. In some embodiments, two reference chips, each with a reference location may be used, or a single reference chip with two separate reference locations.

In yet another embodiment of the present invention, a metrology system includes at least one reference location and an ellipsometer that measures the reference location for calibration. The ellipsometer includes a polarization state generator, including an electromagnetic source, the polarization state generator produces an electromagnetic beam of known polarization state that is incident on the at least one reference location during calibration, a spatially or temporally variable phase retarder in the path of the electromagnetic beam after the sample; and at least one detector that receives the electromagnetic beam after is incident on the at least one reference location. The ellipsometer further includes a computer system coupled to the at least one detector; the computer system having a storage medium and a computer-usable medium having computer-readable program code embodied therein for producing an initial measurement of the at least one reference location and storing the initial measurement in the storage medium, producing a subsequent measurement of the at least one reference location, and using the using the initial measurement of the least one reference location with the subsequent measurement of the least one reference location to determine the calibration error of the ellipsometer. In some embodiments, two reference chips, each with a reference location may be used, or a single reference chip with two separate reference locations.

### BRIEF DESCRIPTION OF THE DRAWINGS

FIG. 1 shows a simple block diagram view of a typical ellipsometer including a Polarization State Generator (PSG), a sample and a Polarization State Detector (PSD).

FIG. 2 is a block diagram of a conventional photoelastic modulator ellipsometer (PME).

FIG. 3 is a block diagram of an ellipsometer with no moving parts and no phase modulator in accordance with an embodiment of the present invention.

FIG. 4 shows a perspective view of the PSD from the ellipsometer in FIG. 3 when used in spectroscopic mode.

FIG. 5 shows a reflecting diffraction grating that expands and collimates the beam in the PSD.

FIG. 6A shows a lens system to expand and collimate the beam to cover the entire PSD detector area.

FIG. 6B shows an etalon that is used to spatially expand the reflected beam into several discrete beams to cover the entire PSD detector area.

FIG. 6C shows transmission diffraction grating that is used to spatially expand the reflected beam to cover the entire PSD area.

FIGS. 7A, 7B, and 7C show three embodiments of a variable retarder that may be used in the PSD shown in FIG. 3

FIG. 8 shows a perspective view of an ellipsometer with no moving parts indicating the calibration parameters.

FIG. 9 shows a representation of the polarization state of an electromagnetic beam in terms of its ellipsometric angles χ and Q.

FIG. 10A shows the modulated intensity signal detected by the multi-element detector.

FIG. 10B shows the same modulated intensity detected by three detectors, which collect the partial integrals of the modulated intensity.

FIG. 11 is a block diagram of a photopolarimeter in accordance with an embodiment of the present invention.

FIG. 12 is a block diagram of an interferometer in accordance with an embodiment of the present invention.

FIG. 13 shows a reference chip arrangement that may be used to calibrate a metrology instruments, such as an ellipsometer, in accordance with an embodiment of the present invention.

FIGS. 14A and 14B show side views of two reference chips.

FIG. 15 is a flow chart of one embodiment of calibrating a metrology instrument, such as an ellipsometer, with two reference chips.

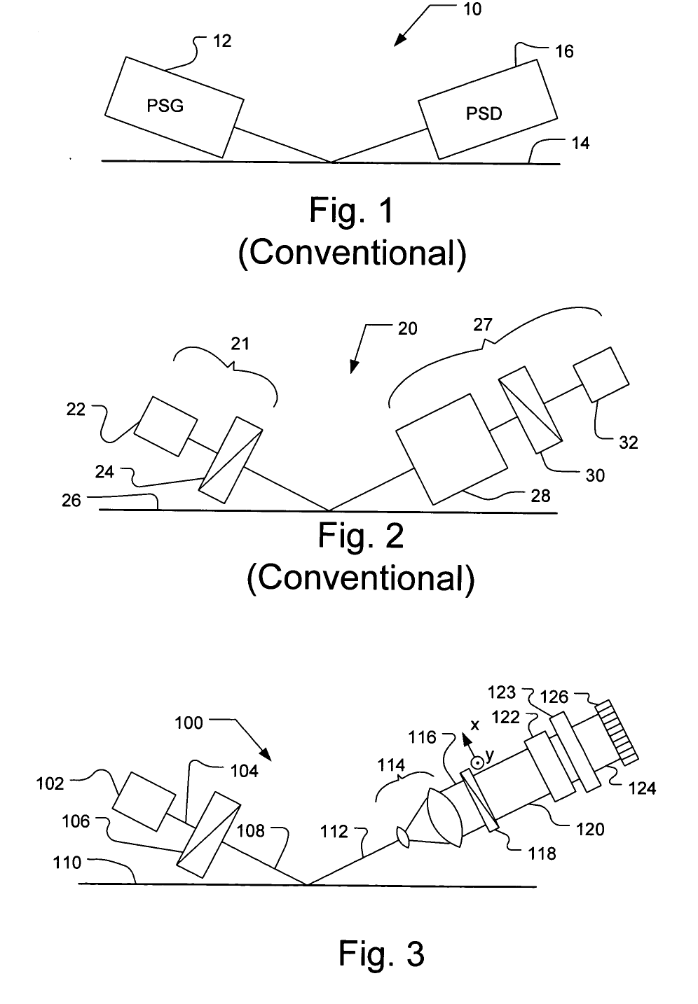

### DETAILED DESCRIPTION

In accordance with an embodiment of the present invention, a metrology device, such as an ellipsometer, has no moving parts and no temporal phase modulator. Such a metrology device is described in U.S. patent application Ser. No. 09/929,625, filed Aug. 13, 2001, entitled “Metrology Device and Method Using a Spatial Variable Phase Retarder”, which is incorporated herein by reference. FIG. 3 shows a block diagram of an ellipsometer 100 in accordance with an embodiment of the present invention. After the light beam of known polarization state is reflected from the sample 1 10, the beam is expanded and passed through a variable retarder 118 to introduce a spatially dependent phase shift. The expanded beam then passes through a polarizer and the intensity is measured using multi-element detector 126. Ellipsometer 100 may be used advantageously for semiconductor thin film applications. Due to its small size, it may be integrated into various semiconductor processor tools.

As shown in FIG. 3, ellipsometer 100 includes an electromagnetic source 102 that generates a collimated beam 104 of monochromatic or broadband radiation that is transmitted through polarizer 106 to produce a polarized beam 108. The polarized beam 108 is incident on and interacts with the sample surface 110 to produce a reflected beam 112. Reflected beam 112 has a modified polarization state compared to polarized beam 108. It should be understood that if desired, ellipsometer 100 may operate in transmission mode in which case the beam passes through the sample. For the sake of simplicity, the present disclosure will describe ellipsometer in reflection mode using a reflected beam, with the understanding that a transmitted beam may alternatively be used.

After reflection from the sample surface 110, the reflected beam 112 is expanded in the plane of the drawing (the x direction) by expander 114 to produce expanded beam 116. It should be understood, however, that beam expander 114 is used to shape the beam so that it adequately fills the variable retarder 118 and a multi-element detector 126 with the reflected signal. If the beam adequately fills the variable retarder 118 and multi-element detector 126, e.g., if electromagnetic source 102 produces the properly shaped beam, beam expander 114 is unnecessary.

The expanded beam 116 is then transmitted through a variable retarder 118 whose geometry is matched to the shape of the expanded beam. The variable retarder 118 has the property of creating a relative phase difference δ between the electric field components parallel (ordinary or o) and perpendicular (extraordinary or e) to the optical axis of the variable retarder 118 in the x direction. The resulting phase shifted beam 120 is then transmitted through a polarizer (linear polarizer) 122. A multi-element detector 126 then records the intensity of resulting beam 124. The detector geometry is chosen to match the geometry of the beam expander 114 and variable retarder 118. The multi-element detector 126 may be a photodiode array (PDA) or a multi-element charge coupled device (CCD).

It should be understood that if desired, the expander 114 and variable retarder 118 may be located in the PSG, i.e., before the sample surface 110. In this embodiment, for example, the expanded beam is focused onto the sample surface 110.

In a spectroscopic embodiment, broadband radiation is emitted from source 102. Additionally, the light beam must be expanded in the y direction, which will be described below. An additional optical component, such as an interferometric filter 123, is required to separate the various wavelengths of the beam. An appropriate interferometric filter 123 has a linear variation of the transmitted wavelength in the y direction. The filter 123 can also be made up of individual interferometric elements. Interferometric filters are composed of stacks of thin films with different thicknesses chosen such that essentially only one wavelength is transmitted through the filter. It is possible to construct an interferometric filter employing a gradient in thickness of the thin films in one direction such that a continuous spectrum of wavelength filters is obtained. These kinds of filters may be custom-manufactured by, e.g., Barr Associates, Inc. located in Westford, Mass. With the gradient oriented in the y direction and a multi-element detector 126 that has elements in the x and y directions, the detector 126 maps the intensity of the resulting beam as a function of retardance δ in the x direction and as a function of wavelength λ in the y direction. The intensities recorded by the detector 126 can then be analyzed to obtain the ellipsometry angles ψ and Δ as a function of wavelength.

The interferometric filter 123 is preferentially located immediately preceding the detector 126 to minimize adverse optical effects. It could also be located anywhere after the beam is expanded in the y direction before the detector 126.

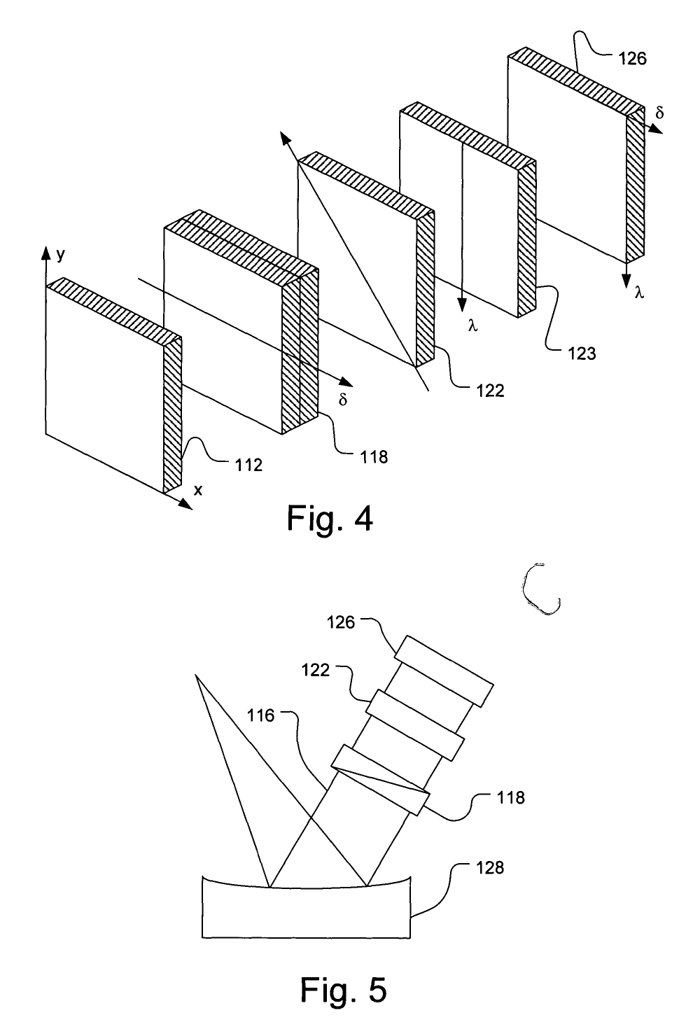

FIG. 4 shows a perspective view of the PSD after beam expansion in ellipsometer 100 in FIG. 3 where the expanded beam 112 is illustrated as plate 112 for the sake of simplicity. As shown in FIG. 4, spatial variable retarder 118 varies the phase δ along the x-axis and interferometric filter 123 varies the wavelength λ along the y-axis. The polarizer 122 creates the sinusoidal modulation of the intensity. Thus, as illustrated in FIG. 4, the detector 126 measures the intensity of the light beam as a function of phase δ along the x-axis and wavelength λ along the y-axis.

Other hardware configurations can be devised for spectroscopic ellipsometry in accordance with the present invention. For example, as shown in FIG. 5, a reflecting diffraction grating 128 is used to collimate the beam in reflection in the x direction as well as separate the wavelengths in the signal by diffraction in the y direction. In this case, the reflecting diffraction grating 128 replaces the interferometric filter 123 shown in FIGS. 3 and 4 and the collimating components of the beam expanding optics 114 shown in FIG. 3. In this configuration, the reflecting diffraction grating 128 operates as part of the expander in the ellipsometer used to expand the reflected beam to fill the variable retarder 118. Transmission gratings can also be employed to spread the beam in the y direction.

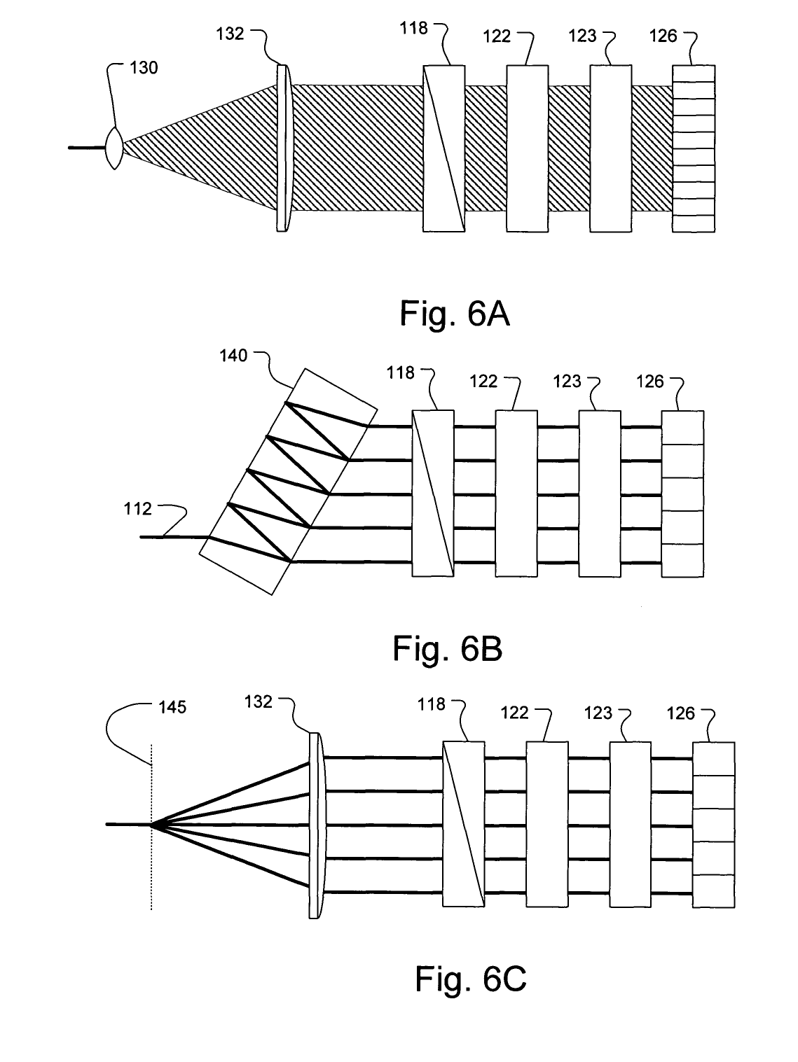

Numerous techniques can be devised to expand the reflected beam 112 to fill the variable retarder 118 and detector 126. For example, as shown in FIG. 3 and in FIG. 6A, lenses 130 and 132 can be used to expand and collimate the reflected beam 112 to cover the desired PSD area. Alternatively, as shown in FIG. 6B, an etalon 140 can be used to divide the reflected beam 112 into a plurality of discrete beams to functionally spatially expand the beam. Multiple reflections inside the etalon 140 generate parallel beams of equal intensity from a properly coated etalon. The detector elements in detector 126 should then be aligned to the discrete beams produced by the etalon 140. Diffractive optics such as a grating 145 can also be used, along with collimating lens 132, to spatially expand the beam into a plurality of individual beams of equal intensity, as shown in FIG. 6C.

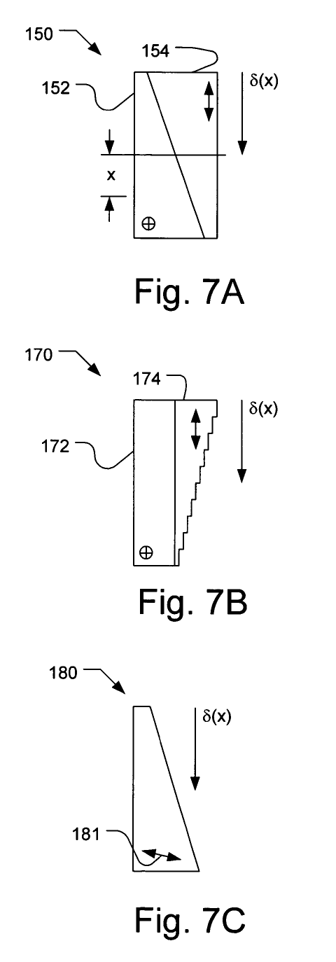

FIGS. 7A, 7B, and 7C show three illustrative variable retarders that may be used with the present invention. The variable retarder 150 shown in FIG. 7A, consists of two wedged plates 152 and 154 composed of birefringent material whose outer surfaces are orthogonal to the beam propagation direction. The optical axes of the plates 152 and 154 are perpendicular to each other. An example of variable retarder 150 is manufactured by InRad Inc. located at New Jersey. The effective retardance for variable retarder 150 assuming an orthogonal incident beam is given by:

$$δ ( x ) = \frac{4 π}{λ} Δ nx tan Φ , \qquad eq . 1$$

where x is the distance from the center of the variable retarder 150, Δn is the birefringence (which is a function of wavelength λ), i.e., the difference between the ordinary and extraordinary refractive indexes assuming both wedges are made of the same material, and Φ is the wedge angle of the internal faces of the two birefringent plates 152 and 154. The angle Φ is preferably chosen so that the retardance δ varies over a range of at least 2π radians for the wavelengths of interest. An additional complexity is that the o and e beams start to diverge at the interface of the two wedges and continue to diverge at the exiting air interface. Therefore, Φ should be chosen as small as possible to minimize the separation between the two polarization components. As shown in FIG. 3, it is desirable to locate the detector 126 as close as possible to the variable retarder 118. Alternatively, a lens following the variable retarder 118 may be used to correct this divergence.

FIG. 7B shows another example of a variable retarder 170 composed of two plates. The first plate 172 has two parallel faces. The second plate 174 has one flat face and a second face with a series of steps of different thicknesses. If desired, the second plate 174 may have a continuously changing thickness rather than a series of steps. The optical axes of the first plate 172 and the second plate 174 are perpendicular to each other similar to the variable retarder 150 described in FIG. 7A. The relative phase difference δ is once again a function of position from the center of the plate. The steps in plate 174 could also be varied in thickness in the y direction for spectroscopic applications to maintain a constant phase delay for each wavelength. This configuration of a variable retarder does not result in a divergence of the two o and e components of the polarized beam. The variable retarder shown in FIG. 7B is also useful in an interferometer.

FIG. 7C is another example of a variable retarder 180 composed of a single wedge. Variable retarder 180 is a made up of a single plate of birefringent material with non-parallel faces. The optical axis must be at a very small angle (almost parallel) to the beam propagation direction as indicated by arrow 181. Thus, the optical axis is at an oblique angle with the direction of propagation of the electromagnetic beam. This geometry creates an effective birefringence given by the projection of the ordinary and extraordinary indices of refraction to the plane perpendicular to the direction of propagation.

It should be understood that other variable retarders could be used. For example, a liquid crystal array, where it is possible to control the birefringence of individual pixels in the x and y directions may be used, as described in T. Horn and A. Hofmann, “Liquid Crystal Imaging Stokes Polarimeter”, ASP Conference Series Vol. 184, pp. 33-37 (1999), which is incorporated herein by reference. Moreover, a variable retarder that uses artificial dielectrics may be used, such as that described in D. R. S. Cumming and R. J. Blaikie, “A Variable Polarization Compensator Using Artificial Dielectrics”, Opt. Commun. 163, pp. 164-168 (1999), which is incorporated herein by reference.

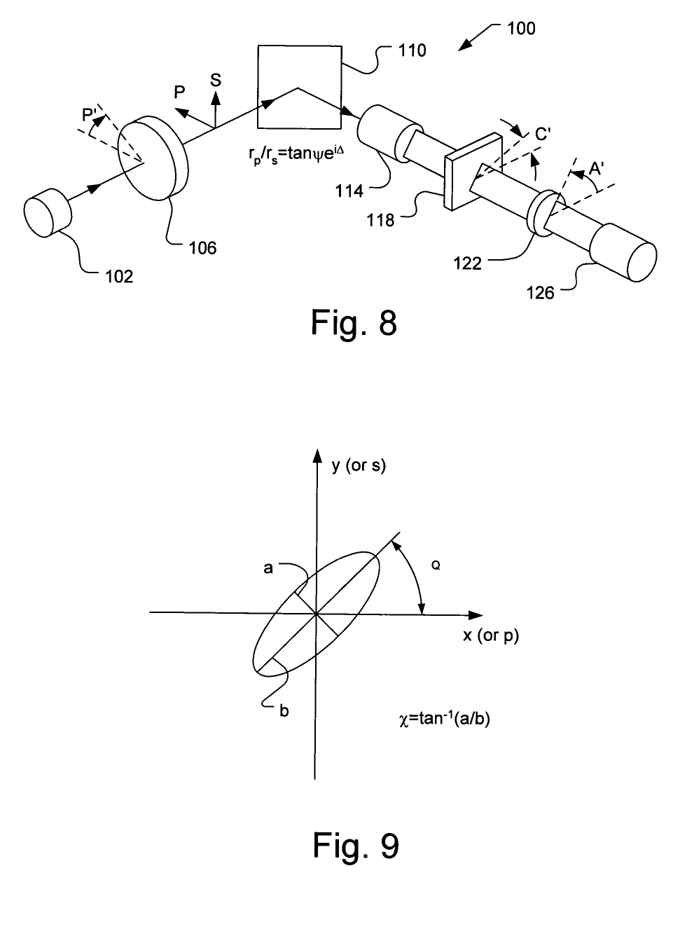

For the system shown in FIG. 3, the Mueller formalism can be used to yield the following dependence for the intensity as measured by the multi-element detector 126 as a function of δ(x):
I=I₀{1+sin 2(C′−A′) sin 2(C′−Q) cos δ(x) cos 2χ+cos 2(C′−A′) cos 2(C′−Q) cos 2χ−sin 2(C′−A′) sin δ(x) sin 2χ} eq. 2

where I₀ is the intensity without polarization, C′ is the angle of the optical axis of the variable retarder 118, and A′ is the angle of the transmission axis of the polarizer 122. Both the C′ and A′ angles are measured with respect to the plane of incidence, as shown in FIG. 8, which shows a perspective view of ellipsometer 100. The retardance of the variable retarder 118 is represented in equation 2 by δ(x). The ellipticity angle is represented by χ and the tilt angle defining the polarization state of the reflected beam is represented by Q.

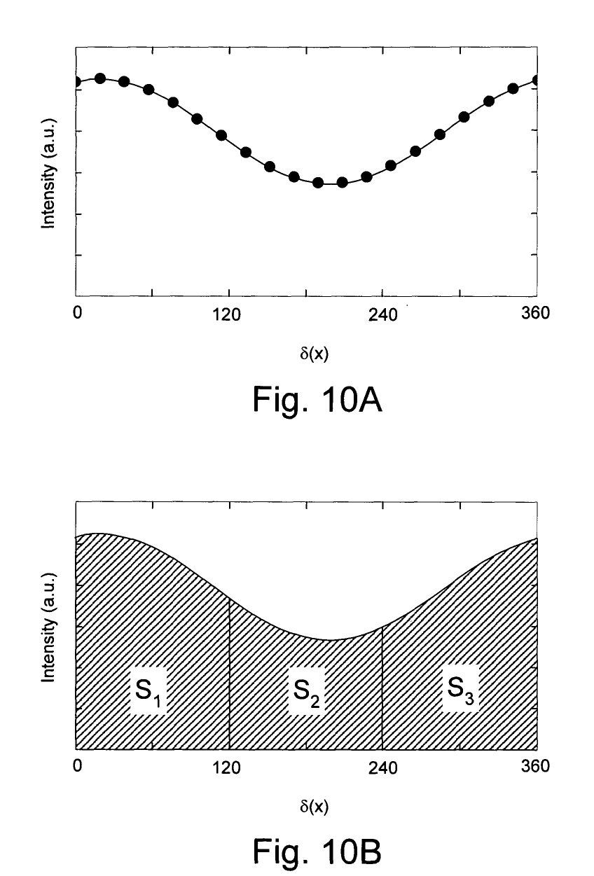

FIG. 9 is a representation of a polarization state of an electromagnetic beam in terms of its ellipsometry angles χ and Q, with the x-axis parallel to the plane of incidence. When Q is greater than zero, the angle is defined as counter-clockwise for an incoming beam, as shown in FIG. 9. The sign of χ determines the handedness of the polarization state, i.e., positive χ indicates left-handed rotation, whereas negative χ indicates right-handed rotation, also shown in FIG. 9.

The quantities χ and Q are related to the ellipsometry angles ψ and Δ by:

$$\begin{matrix}cos 2 ψ = \frac{cos 2 {P}^{′} - cos 2 Q cos 2 χ}{1 - cos 2 Q cos 2 χ cos 2 {P}^{′} } & eq . 3 A \\ tan Δ = - \frac{tan 2 χ}{sin 2 Q} & eq . 3 B\end{matrix}$$

where P′ is the angle of the transmission axis of the polarizer 106 with respect to the plane of incidence, as shown in FIG. 8. Ellipsometry angles and equations 3A and 3B are described in more detail in Joungchel Lee, P. I. Rovira, Ilsin An, and R. W. Collins, “Rotating-Compensator Multichannel Ellipsometry: Applications for Real Time Stokes Vector Spectroscopy of Thin Film Growth”, Rev. Sci. Intrum. 69, pp. 1800-1810 (1998), which is incorporated herein by reference. The ellipsometry angles ψ and Δ can then be modeled using, e.g., the Fresnel formalism to obtain the thin film properties of the sample.

In order to obtain χ and Q, the intensity given by equation 2 may be analyzed, e.g., using regression analysis, once the intensities of the multi-element detector 126 are measured. An additional approach shows the normalized intensity written as:
I′=1+α cos δ+β sin δ eq. 4
Where α and β are described by the following equations:

$$\begin{matrix}α = \frac{sin 2 ( {C}^{′} - {A}^{′} ) sin 2 ( {C}^{′} - Q ) cos 2 χ}{1 + cos 2 ( {C}^{′} - {A}^{′} ) cos 2 ( {C}^{′} - Q ) cos 2 χ} & eq . 5 A \\ β = \frac{- sin 2 ( {C}^{′} - {A}^{′} ) sin 2 χ}{1 + cos 2 ( {C}^{′} - {A}^{′} ) cos 2 ( {C}^{′} - Q ) cos 2 χ} & eq . 5 B\end{matrix}$$

One advantageous configuration of angles is P′=45°, C′=0°, and A′=−45°, but other configurations may be used.

FIG. 10A shows the modulated intensity signal in arbitrary units detected by the multi-element detector 126. If the intensity is modulated by 2π radians and the photodetector array contains N detectors, as shown in FIG. 10A, the Fourier coefficients can be obtained from the following relations:

$$\begin{matrix}α = \frac{1}{{I}_{sum}} {\sum }_{q = 1}^{N} {I}_{exp , q} cos {δ}_{q} , & eq . 6 A \\ β = \frac{1}{{I}_{sum}} {\sum }_{q = 1}^{N} {I}_{exp , q} sin {δ}_{q} , & eq . 6 B \\ {I}_{sum} = {\sum }_{q = 1}^{N} {I}_{exp , q} . & eq . 6 C\end{matrix}$$

In an alternative approach, using a multi-element detector with a limited number of elements, the output of each element is proportional to the area of the intensity curve, as shown in FIG. 10B for the case of a three-element detector. This technique has the potential to improve the data collection throughput. In FIG. 10B, each element covers one third of the total modulation. Each detector will collect an intensity that is proportional to the partial integrals of I(x). The integrals of the intensity Sⱼ (j=1, 2, 3, . . . ) are referred to in the literature as Hadamard sums. Therefore, for the case of three detectors and a complete modulation period, the following can be written:

$${S}_{m} = {{\int }_{2 π ( m - l ) / 3}}^{2 π m / 3} {I}_{0} [ 1 + α cos ( δ ( x ) ) + α cos ( δ ( x ) ) ] ⅆ δ ( x ) , \qquad eq . 7$$

where m=1, 2, 3.
Thus:

$$\begin{matrix}{S}_{1} = {I}_{0} ( \frac{2}{3} π + \frac{\sqrt{3}}{2} α + \frac{3}{2} β ) , & eq . 8 A \\ {S}_{2} = {I}_{0} ( \frac{2}{3} π - \sqrt{3} α ) , & eq . 8 B \\ {S}_{3} = {I}_{0} ( \frac{2}{3} π + \frac{\sqrt{3}}{2} α - \frac{3}{2} β ) . & eq . 8 C\end{matrix}$$

Inverting these equations, the normalized Fourier coefficients will be given by:

$$\begin{matrix}α = \frac{2 π}{3 \sqrt{3}} \frac{( {S}_{1} + 2 {S}_{2} - {S}_{3} )}{( {S}_{1} + {S}_{2} + {S}_{3} )} , & eq . 9 A \\ β = \frac{2 π}{3} \frac{( {S}_{1} - {S}_{3} )}{( {S}_{1} + {S}_{2} + {S}_{3} )} . & eq . 9 B\end{matrix}$$

Summarizing, in order to obtain the ellipsometry angles ψ and Δ associated with a thin film stack on a sample, the intensity as a function of detector position is first measured. The quantities α and β are calculated either from equations 6A-6C, or equations 9A-9B. Next, the angles χ and Q are calculated from equations 5A-5B after inversion. Finally, the ellipsometry angles ψ and Δ are obtained from equations 3A-3B.

The PSD of the ellipsometer 100 can also be used as a photopolarimeter, i.e., a beam of unknown polarization state (χ, Q) can be measured by the PSD. The collected intensity can then be analyzed to obtain (χ, Q), which defines the polarization state of the incoming beam as in FIG. 9.

In addition, it should be understood that PSD shown in FIG. 4 may be used with metrology instruments other than the ellipsometer shown in FIG. 3. For example, the polarization state detector of FIG. 4 may be used as a photopolarimeter. A photopolarimeter is used to analyze the polarization state of an electromagnetic beam. Photopolarimeters are used, e.g., in the telecommunication industry, as it is often desirable to know the polarization state of beams emanating from an optical fiber. Photopolarimeters are also used in an astrophysics application, in which the polarization state of solar electromagnetic radiation is analyzed.

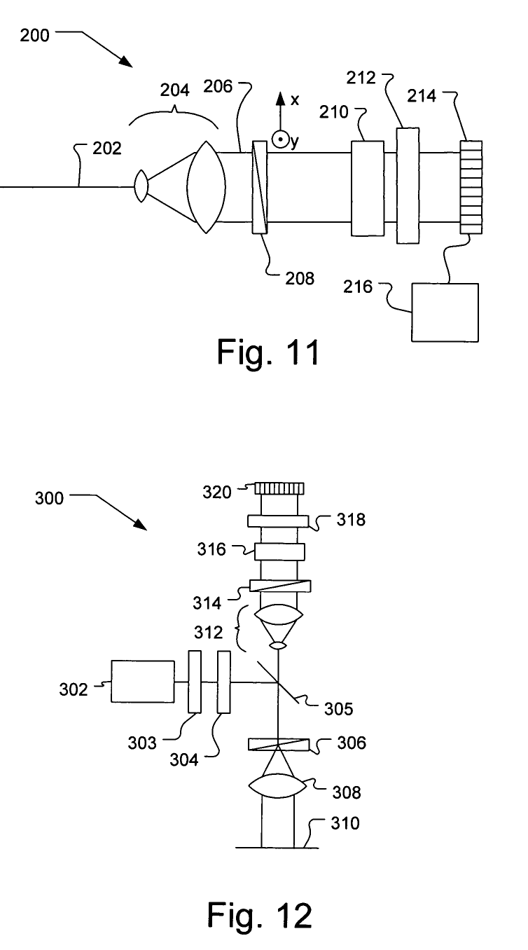

The operation of a photopolarimeter 200, in accordance with an embodiment of the present invention, is described with reference to FIG. 11. An electromagnetic beam 202 that is received by the photopolarimeter 200 is orthogonally incident on the beam expander 204 if beam expansion is required. The expanded beam 205 is incident on the spatial variable retarder 208. If beam expansion is not required, i.e. the received electromagnetic beam 202 is already properly shaped to fill the variable retarder 208 and the detector 214, the beam expander 204 is unnecessary. After transmission through the variable retarder 208, the electromagnetic beam is then linearly polarized by polarizer 210 and collected by the multi-element detector 214. If the electromagnetic beam 202 to be analyzed consists of broadband radiation, the electromagnetic beam must also be expanded by interferometric filter 212 in the direction orthogonal to the phase variation direction imposed by the spatial variable retarder 208. Thus, for example, the spatial variable retarder 208 varies the phase along the x-axis and the interferometric filter 212 varies the wavelength along the y-axis. The data is then analyzed by a data processing machine 216 coupled to the multi-element detector 214 to yield the polarization state of the electromagnetic beam 202.

To obtain the polarization state of the electromagnetic beam 202 from the collected intensities from the multi-element detector 214, the data processing machine 216 implements software to calculate the Fourier coefficients α and β from equations 6A-6C or 9A-9B. The particular equations used depend on the detector configuration, as described above. Next, the data processing machine 216 implements software to calculate the tilt angle Q and ellipticity angle χ using equations 5A and 5B. As illustrated in FIG. 9, the angles Q and χ define the polarization state of the incoming electromagnetic beam 202. Software that may be implemented by data processing machine 216 to calculate the Fouirer coefficients α and β from equations 6A-6C or 9A-9B and the tilt angle Q and ellipticity angle χ from equations 5A and 5B may be written by one of ordinary skill in the art.

In addition, if desired, the PSD with or without a beam expander may be used in an interferometer 300, shown in FIG. 12. Interferometer 300 includes an electromagnetic source 302 followed by a half-wave plate 303 and a polarizer 304. A beam splitter 305 directs the electromagnetic beam towards the sample 310. A Wollaston prism 306 splits the light beam into two light beams, which are focused on the sample by lens 308. The two beams are reflected off sample 310 and travel back through lens 308 and prism 306, where the two beams are recombined into a single superimposed beam before passing through beam splitter 305. The beam is then expanded by beam expander 312 and passes through a spatial variable retarder 314. If the beam does not need expanding, as discussed above, beam expander 312 need not be used. The beam passes through a polarizer 316 and an interferometric filter 318 (if desired) prior to being received by multi-element detector 320. Thus, the multi-element detector 320 receives a single superimposed electromagnetic beam. The single beam received by detector 320 is appropriately shaped to fill the detector 320 by beam expander 312 (if beam expansion is necessary) or by other optical elements, e.g., lens 308, prism 306, beam splitter 305, or the light source 302 itself, (if beam expansion is not used). In addition, if desired, spatial variable retarder 314 may be a single plate of birefringent material with non-parallel faces, with the optical axis at a small angle (almost parallel) to the beam propagation direction, as discussed in FIG. 7C.

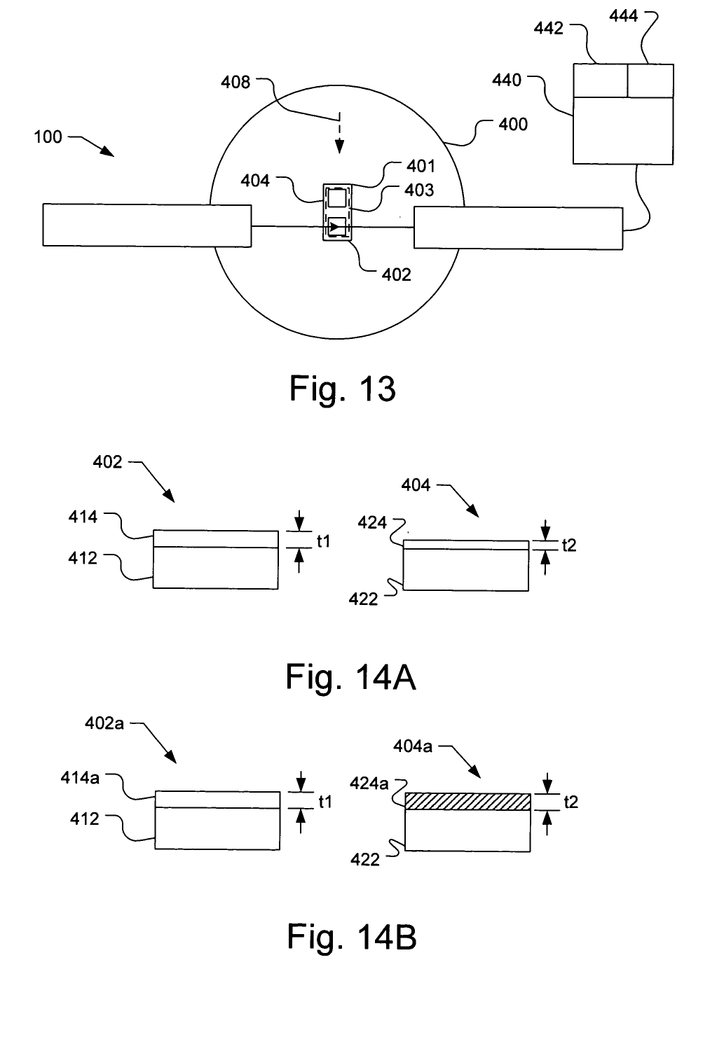

In accordance with another embodiment of the present invention, FIG. 13 shows a reference chip arrangement that may be used to calibrate a metrology device, such as ellipsometer 100. As shown in FIG. 13, two reference chips 402 and 404 may be used to calibrate ellipsometer 100. Reference chips 402 and 404 may be mounted within recess 401 in chuck 400 or placed in another convenient and stable location, exposed either to the air, i.e., the ambient environment, an inert gas, e.g., nitrogen, or held in a vacuum. Reference chips 402 and 404 should be counter-sunk so that they are even with or below the surface chuck 400. Chuck 400 may be, e.g., a polar coordinate chuck located within the processing and/or metrology chamber.

It should be understood that while two reference chips 402 and 404 are shown, if desired, a single reference chip (indicated with broken lines 403) that includes two reference locations, e.g., each having a different optical characteristic, may be used. For the sake of simplicity, the present disclosure will generally two reference chips 402 and 440 interchangeably with two reference locations.

The ellipsometer 100 is coupled to a computer 440, which may be, e.g., a workstation, a personal computer, or central processing unit, e.g., Pentium 4™ or other adequate computer system. Computer 440 may include a storage medium 442 or memory and a computer-usable medium 444 having computer-readable program code embodied therein for producing the measurement results and storing the results in the storage medium. The code is also for using the measurement results to determine whether recalibration is necessary and if so, the amount of recalibration that is necessary. Producing such code is well within the abilities of those skilled in the art in light of the present disclosure.

FIG. 14A shows side views of reference chips 402 and 404. Reference chips 402, 404 include substrates 412, 422 that are covered with layers 414, 424, respectively. By way of example, substrates 412, 422 may be silicon or other appropriate substrate material. The layers 414, 424 may be, e.g., silicon oxide or other appropriate stable material and have different optical characteristic, such as thickness. As can be seen in FIG. 14, layer 414 has a thickness of t1 and layer 424 has a thickness of t2. The thicknesses may range, e.g., between 15 Å and 100 Å, with a difference between t1 and t2 of approximately 20 Å to 100 Å. By way of example, the layers 414 and 424 may be produced with oxides having the same index of refraction. If the metrology device uses a single wavelength of light, the index of refraction of the chips must be known. If the metrology device, on the other hand, uses a plurality of wavelengths, the index of refraction of the reference chips can be solved.

As illustrated in FIG. 14B, in another embodiment, the thickness t1 and t2 may be equal, but the layers 414a and 424a of reference chips 402a and 404a are manufactured from different material so that they have different optical characteristic, such as indices of refraction or absorption. Of course, if desired, the layers 414 and 424 may have different thicknesses, different indices of refraction, and/or different absorption characteristics.

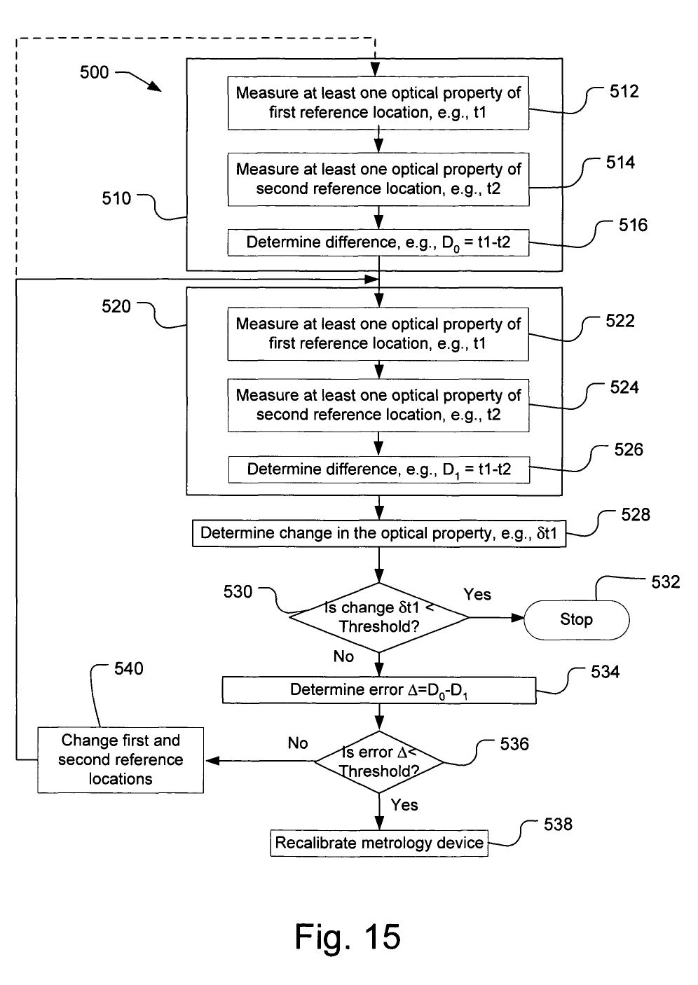

FIG. 15 is a flow chart 500 of one embodiment of determining whether a metrology device, such as ellipsometer 100 or an ellipsometer with temporal phase modulation, needs calibration. Prior to use, ellipsometer 100 is calibrated against a known standard in a conventional manner, which is well known. After the ellipsometer 100 is calibrated, ellipsometer 100 uses initial measurements (block 510) and subsequent measurements (block 520) of optical characteristics of reference chips 402 and 404 to determine if recalibration is necessary. By way of example, subsequent measurements of reference chips 402 and 404 (block 520) may be made at appropriate time intervals, e.g., after a few hours of use, to determine if the ellipsometer 100 is in need of recalibration.

As indicated in FIG. 15, an optical property, such as thickness t1 (or the index of refraction) of a first reference location, e.g., reference chip 402, is measured by ellipsometer 100, as illustrated in FIG. 13, (block 512). When measuring reference chips 402 and 404, the chuck 400 may be raised slightly to place the reference chips 402 and 404 in the focal plane of ellipsometer, particularly, when the top surfaces of reference chips 402 and 404 are below the top surface of chuck 400. The chuck 400 then moves to place the second reference location, e.g., reference chip 404, under ellipsometer 400, indicated by arrow 408. Ellipsometer 100 then measures an optical property, such as thickness t2 (or the index of refraction) of the second reference location, e.g., reference chip 404 (block 514). The optical properties of one or both of the reference locations is stored for future use. The initial difference D₀ between the optical properties is determined, e.g., (D₀=t1−t2) (block 516). The difference D₀ may also be stored for future reference.

After some time, e.g., after a few hours or after a number of sample measurements, the same optical properties of the two reference locations, e.g., thicknesses t1 and t2 of reference chips 402 and 404, are again measured (blocks 522 and 524). The current difference D₁ between the optical properties (D₁=t1−t2) is then determined (block 526).

The optical property measured in block 520 of one of the reference locations, e.g., t1_{current}, is compared to the optical property measured in block 510, e.g., t1ᵢₙᵢₜᵢₐₗ, to determine the change (δt1=t1_{current}−t1ᵢₙᵢₜᵢₐₗ) in the measurement (block 528). If the change (δt1) is less than a threshold, e.g., a 0.2 Å, (block 530) the metrology device does not need calibrating and the recalibration process can stop (block 532).

If the change (δt1) is greater than the threshold, e.g., a 0.2 Å, (block 530) the metrology device may need to be recalibrated. To determine if the metrology device needs to be calibrated or if the reference locations have been damaged, e.g., by intense or UV light exposure, the current difference D₁ is compared to the initial difference D₀ to determine the error in the reference locations (Δ=D₀−D₁) (block 534). If the error Δ is less than a threshold, e.g., 0.1 Å, (block 536) then it is unlikely that the reference locations have been damaged and the metrology device is recalibrated using the change (δt1), which is the calibration error. Calibrating metrology devices, such as ellipsometers, is well known in the art.

On the other hand, if the error Δ is greater than the threshold (block 236), then one or both reference locations are probably damaged. In one embodiment, the first and second reference locations may be changed (block 54) and the process flows back to block 520. Thus, for example, where two reference chips 402 and 404 are used, different locations on the reference chips 402 and 404 may be used. Alternatively, the reference chips may be replaced, in which case the process would flow back to block 510 as indicated by the broken line in FIG. 15.

It should be understood that while this embodiment of present invention is disclosed with a particular order of acts, the present invention includes functional and/or mathematical equivalent acts. For example, rather than determining and storing the initial difference D₀, the initial thickness measurements t1 and t2 may be stored and the difference D₀ determined at a later time. The subsequent thickness measurements may then be made and compared directly to the initial thickness measurements. The error may then be determined based on the differences between subsequent and initial thickness measurements. Further, both the change (δt1) and the error Δ may be compared to their thresholds simultaneously or nearly simultaneously before a decision to stop, recalibrate, or change reference locations is made.

Further, in accordance with another embodiment, a single reference location may be used to determine whether an ellipsometer 100 or an ellipsometer with temporal phase modulation, needs calibration. The process of using a single reference location to determine whether an ellipsometer needs calibration is similar to that described above, however, the second reference location is not used and the difference between the first and second reference locations is not determined. If the change in the optical property of the single reference location, e.g., δt1=t1_{current}−t1ᵢₙᵢₜᵢₐₗ, is greater than a threshold, the ellipsometer is recalibrated.

Although the present invention is illustrated in connection with specific embodiments for instructional purposes, the present invention is not limited thereto. Various adaptations and modifications may be made without departing from the scope of the invention. For example, optical properties such as thickness, index of refraction and/or absorption may be used. Further, the present invention may be used with single or multiple wavelength devices. In addition, only a single reference location may be used in accordance with an embodiment of the present invention. When a single reference location is used, however, error in calibration may result if the reference location is damaged. Therefore, the spirit and scope of the appended claims should not be limited to the foregoing description.

1. A method of determining the calibration error of a metrology instrument, the method comprising:
producing initial measurements of a first reference location and a second reference location, wherein the first reference location and the second reference location are designed with different optical properties to produce different measurement results;
producing subsequent measurements of the first reference location and the second reference location;
using the initial measurements of the first reference location and the second reference location and the subsequent measurements of the first reference location and the second reference location to determine the calibration error of the metrology instrument.

2. The method of claim 1, further comprising:
comparing the initial measurement of the first reference location and the subsequent measurement of the first reference location to obtain a measurement difference;
comparing the initial measurement of the first reference location and the initial measurement of the second reference location to obtain an initial difference; and
comparing the subsequent measurement of the first reference location and the initial measurement of the second reference location to obtain a subsequent difference;
wherein using the initial measurements of the first reference location and the second reference location and the subsequent measurements of the first reference location and the second reference location comprises using the measurement difference and the change between the initial difference and the subsequent difference to determine a calibration error of the metrology instrument.

3. The method of claim 2, wherein the measurement difference is the calibration error when the measurement difference is greater than a first threshold and the change between the initial difference and the subsequent difference is below a second threshold.

4. The method of claim 1, wherein the different optical properties comprise at least one of thickness, index of refraction and absorption.

5. The method of claim 1, wherein producing initial measurements of a first reference location and a second reference location comprises measuring at least one layer on a first reference chip and measuring at least one layer on a second reference chip.

6. The method of claim 1, wherein producing initial measurements of a first reference location and a second reference location comprises measuring a first reference location and a second reference location a reference chip.

7. A method comprising:
producing an initial measurement of at least one reference location using an ellipsometer;
producing a subsequent measurement of the at least one reference location with the ellipsometer;
using the initial measurement of the least one reference location with the subsequent measurement of the least one reference location to determine the calibration error of the ellipsometer.

8. The method of claim 7, the method further comprising:
producing initial measurements of a first reference location and a second reference location, wherein the first reference location and the second reference location are designed to produce different measurement results;
producing subsequent measurements of the first reference location and the second reference location; and
using the initial measurements of the first reference location and the second reference location and the subsequent measurements of the first reference location and the second reference location to determine the calibration error of the ellipsometer.

9. The method of claim 8, further comprising:
comparing the initial measurement of the first reference location and the subsequent measurement of the first reference location to obtain a measurement difference;
wherein the measurement difference is the calibration error when the measurement difference is greater than a first threshold.

10. The method of claim 9, further comprising:
comparing the initial measurement of the first reference location and the initial measurement of the second reference location to obtain an initial difference; and
comparing the subsequent measurement of the first reference location and the initial measurement of the second reference location to obtain a subsequent difference;
wherein the measurement difference is the calibration error when the measurement difference is greater than a first threshold and the change between the initial difference and the subsequent difference is below a second threshold

11. The method of claim 8, wherein producing an initial measurement of a first reference location and a second reference location comprises measuring at least one of the thickness, index of refraction, and absorption of at least one layer at the first reference location and measuring at least one of the thickness, index of refraction, and absorption of at least one layer at the second reference location.

12. The method of claim 11, wherein the first reference location and the second reference location are on separate reference chips.

13. A metrology system comprising:
at least one reference location;
an ellipsometer that measures the reference location for calibration, the ellipsometer comprising:
a polarization state generator, including an electromagnetic source, the polarization state generator produces an electromagnetic beam of known polarization state that is incident on the at least one reference location during calibration;
a phase retarder in the path of the electromagnetic beam after the sample;
at least one detector that receives the electromagnetic beam after is incident on the at least one reference location;
a computer system coupled to the at least one detector; the computer system having a storage medium and a computer-usable medium having computer-readable program code embodied therein for:
producing an initial measurement of the at least one reference location and storing the initial measurement in the storage medium;
producing a subsequent measurement of the at least one reference location;
using the initial measurement of the least one reference location with the subsequent measurement of the least one reference location to determine the calibration error of the ellipsometer.

14. The metrology system of claim 13, comprising a first reference location and a second reference location, wherein the first reference location and the second reference location are designed to produce different measurement results, the system further comprising:
means for producing relative movement between the ellipsometer and the first reference location and the second reference location relative.

15. The metrology system of claim 14, wherein the computer-readable program code embodied therein is further for:
producing an initial measurement of a first reference location and a second reference location and storing the results;
comparing the initial measurement of the first reference location and the initial measurement of the second reference location to obtain an initial difference and storing the initial difference;
producing a subsequent measurement of the first reference location and the second reference location;
comparing the subsequent measurement of the first reference location and the initial measurement of the second reference location to obtain a subsequent difference;
comparing the initial measurement of the first reference location with the subsequent measurement of the first reference location to obtain a measurement difference; and
comparing the initial difference with the subsequent difference to obtain a reference location error;
wherein the calibration error is the measurement difference when the measurement difference is greater than a first threshold and the reference location error is below a second threshold

16. The metrology system of claim 14, wherein the first reference location and the second reference location are on separate chips.

17. The metrology system of claim 14, wherein the first reference location and the second reference location are on the same chip.

18. The metrology system of claim 13, wherein the at least one reference location is in one of a vacuum, inert gas, and ambient environment.
